(19) United States
(12) Patent Application Publication
(10) Pub. No.: US 2001/0056548 A1
(43) Pub. Date: Dec. 27, 2001

(54) Firwall protection in computer network systems

(76) Inventor: J. Seth Blumberg, Los Angeles, CA (US)

Correspondence Address: OPPENHEIMER WOLFF & DONNELLY LLP, 38TH FLOOR, 2029 CENTURY PARK EAST, LOS ANGELES, CA, 90067-3024, US

(21) Appl. No.: 09/739,939

(22) Filed: Dec. 18, 2000

Related U.S. Application Data
(60) Provisional application No. 60/171,035, filed on Dec. 16, 1999.

(51) Int. Cl. H04L 12/22

(52) U.S. Cl. 713/201; 709/229

(57) ABSTRACT

A firewall for data or computer communications and networks using a physically separate security machine to safeguard and secure the main computer. The physical electrical separation contains only the necessary hardware to receive software from a personal or main computer and the software is erased automatically by the security machine after use. The security machine cannot be hardwired to both the owner's main computer and network at the same time and be functional.

### BACKGROUND OF THE INVENTION

This invention embodies a new type of firewall for data or computer communications and networks. The firewall adds a new, significant protection which can stop intruders, unauthorized users or computer hackers from accessing the files of the owner or authorized computer operator.

Currently, when a computer user sends information through a network, such as the internet, the world at large has an opportunity to intrude or “hack” into the authorized user's computer.

Currently, many hackers can add software code to any unknowing person's computer that uses the Internet, that instructs an unknowing person's computer (or UPC) to always send an e-mail to the hacker that provides all new information input into the UPC. As a result, any typed letter or privately sent e-mail is stolen by the hacker. The source code of an operating system, once known by a hacker, can be infiltrated and any security can eventually be bypassed. Even if a state of the art encryption system creates a code that is only known by the sender and the receiver of the information, and that information is sent or e-mailed over a transmission line, telephone line or network, if a hacker is good enough, he or she can just search through the underlying source code of the operating system of the owner's main computer or the and find out where the secret code is stored and then access or read the code and use the code to break in to the system or file.

The secret encryption code used in the current state of the art R.S.L. 512 bit encryption security system was cracked by an expert team of hackers in late 1999 after they were assigned to that task which was previously thought to be impossible. Now, experts are advising that systems should change their security to the new 10024 bit security system even though the experts indicate that it is only a matter of time until the new 1024 bit R.S.L. security is also cracked. This means that once a computer is connected to a network, it is always vulnerable if someone is willing to pay enough money and use smart enough experts to penetrate or hack into it.

### SUMMARY OF THE INVENTION

This invention creates a machine that can protect the owner's main computer from intrusion.

This invention concerns a machine, the “security machine” (also called SM) which is physically separate from a main computer. This separate machine has the purpose of safeguarding and securing the main computer through a few crucial methods. The term “physically separate” means a system which is not hard wired to a main computer. Also included is a connection through an infrared or other link which can be physically broken. The term physically separate means a device which is physically different, and it also includes devices which are contained in the same chassis. The physical separation means the ability to electrically be totally isolated.

The SM provides not only a physically separate dedicated machine for communications, but also this SM would not contain any software of any kind until the minimal software required for one single transmission of data or one communication is downloaded from the main computer to the SM.

The SM arrives to the customer containing only hardware—specifically a special new chip which has the minimal circuitry required for the sole purpose of the SM. The SM can come with a CD or floppy disc or other storage system for software which is downloaded onto the personal or main computer and then some of that software, the minimal necessary software) is downloaded from the personal computer to the SM for each single use of the SM. After each use of the SM, the minimal, necessary software on the SM which was downloaded each time from the user's personal or main computer is erased automatically by the SM.

The SM contains no physical place or capability for any software memory when the electric power supply to the SM is shut off. The SM is disconnected from the main computer prior to transmission or sending of any information or data of any kind, because the SM is hardwired so that it cannot be connected to both the owner's main computer and a network or telephone connection at the same time and be able to function. The result is that the SM cannot retain or hold any “hacker's virus” or unauthorized intruder's software codes when it is reattached to the main computer just prior to the next communication.

The result is that the SM functions as a new, drastically improved, more secure barrier or firewall between all the confidential or private information on the main or personal computer and the world at large as connected through the internet or other network or communication system.

This invention allows communications from a private person's computer to be far less penetrable. Additionally, this invention increases security against computer viruses or bugs infiltrating a private person's computer (PPC). The SM is physically disconnected from the PPC after each use, and all the SM's memory including hard drive and RAM and any other software memory is erased after each use so that the SM will not pass along any virus to the PPC.

All of the SM's Software memory (which does not include the chip which cannot accept any changes in its programming) is erased after each time that the SM sends information through the internet or other network and the PC is protected from hacker infiltration by the methods listed below:

First, the hardware memory chip contains no hard drive memory or RAM memory or other memory that survives a physical electrical disconnection of the power supply to the SM. Each time the SM sends an e-mail or completes another type of information transmission, the SM's chip or hardwiring will cause the SM to power off so that all software on the SM will be erased.

Second, the entire SM is designed so that it can withstand being physically demagnetized after each use. One embodiment of the SM is designed with an internal demagnetizer so that after each use it is demagnetized automatically. Demagnetization erases everything in the SM's memory—only the chip and other hardware remains intact for the next unadulterated use.

Each use of the SM would be facilitated with a minimal operating system that would be downloaded with every separate use (and then the SM erases it after every use) from the owner's main computer along with the file or information to be transmitted or sent to another computer via a network or other communications link.

One significant reason that this invention creates such a new and dramatic improvement in firewall effectiveness or security for computer or electronic transmissions or communications is that currently the typical personal computer has software code such as the operating system that is vulnerable to an intruder or hacker.

The SM can transmit information over a network such as the Internet and be extremely confident that the communication process would not allow any intrusion into the owner's main computer. It is, therefore, theoretically possible that any individual SM communication could be intercepted, and the owner's main computer and other files would remain protected and not even physically connected to the SM And even if the SM was eavesdropped on for that one communication, the automatic erasing of all software and operating system in the SM would ensure that the owner's main computer would not be infiltrated or bugged in any way as long as the owner followed all precautions as indicated by the directions for the SM.

Additionally, the SM can have constantly new operating systems that are routinely changed and compiled and sent to the computer user. In this way the operating systems of the SM will always be changing just in case any one operating system or version if the SM software or operating system was ever infiltrated by a hacker.

A third method that enables the SM to ensure the erasure of all software memory and ensures that no tampering has occurred is that the minimal hardware of the SM, is designed to be pulled out easily from the body of the SM machine and replaced with a new fresh duplicate. The old hardware or chip can be demagnetized and tested for any problems by the owner with other included optional testing equipment. Demagnetization erases computer software including source code so that a hacker has no operating system or software of any kind to augment or disturb by hacking into it.

A fourth method that the SM uses to create a proper firewall is that the SM may be licensed o all computer manufacturers with directions that if the SM is housed in the same box as the rest of the personal computer or other computer, the wire that connects the main or personal computer to the SM would be visible on the outside of the personal computer so that the owner could visually confirm that there was no security breach causing a direct connection of the personal computer directly to the internet or other network or communication device. The computer owner would first connect the main or personal computer to the SM and transfer one file to the SM. The computer user would then disconnect the wire between the computer and the SM, thus the computer would be secure while the SM is connected to the internet or other communication or network

The invention which relates to an apparatus, system and method of firewall protection is further described with reference to the following drawings.

This invention also embodies the use of the machine of the Internet or other network; to remotely control the connection and disconnection of fiber, copper, or other data transfer cable or connectivity (hereinafter “connectivity”) connected to computer equipment that is physically located in different facilities anywhere in the world.

With this functionality, the user can remotely connect or disconnect the connectivity of many pieces of computer equipment simultaneously or in any specific order. With this invention, bank records of transfers and other electronic security sensitive data transmissions can be authorized and/or approved and/or recorded or data stored regarding such data transfer or transmission.

With this invention, the user can have her or his bank record or balance updated, or other action requiring electronic security or privacy, simultaneously as her or his computer equipment authorizes and records the data transfer. Should the user's remote computer equipment located in a different location from the bank's computer equipment not be disconnected by use of the invention, then the bank transfer would not be authorized.

This invention also embodies the software that directs the simultaneous or successive remote connecting and disconnecting of the computer equipment physically located in diverse locations. This provides high electronic security by allowing the user to confirm that her or his computer equipment is actually physically disconnected from the Internet as well as any and all other networks that provide connectivity to the public. The layman can use this device without disturbing or corrupting any technical elements of the network architecture or systems architecture because the device does not have to disrupt those systems.

This invention pertains to connecting and/or disconnecting the fiber of copper or other network or Internet connectivity from a server or computer or router or switch or other computer equipment (hereinafter computer equipment) via the Internet or other network so that the user can secure the computer equipment from access by others for privacy and for preventing unauthorized use of the data in the computer equipment.

The user may be a bank or financial institution which needs to disconnect remotely its computer equipment via the machine of the Internet or other network in order to secure the monies held electronically in certain accounts. Among other things this allows users of the invention who are not trained network engineers to be able to remotely from any location with access to the Internet or other network, to connect and disconnect computer equipment without effecting the complex network architecture both hardware and/or software in the routers or other complex computer equipment or software codes.

The user of the invention may use additional security access technology in the process of obtaining remote access to the device embodied by this invention. One embodiment of the invention, among many others, is the use of a solenoid that physically detaches the fiber, copper, or other data transfer cable or connectivity to when the user remotely commands the device embodied by the invention to do so. Other embodiments of methodologies included as a part of this invention to connect or disconnect the fiber, copper or other data transfer cable or other Internet or network connectivity include, but are not limited to, solid state devices, chip based devices, liquid based devices, chemical based devices, solid state devices, other electronic devices, fuel based engines, fuel cell devices, and the like.

### BRIEF DESCRIPTION OF THE DRAWINGS

FIG. 1 is an overall view of a web-based system to provide access to a database management system of a database in relation to the Internet.

FIG. 2 is a graphical illustration of a computer network, namely the Internet.

FIG. 3 is a block diagram of an exemplary computer system for practicing various aspects of the invention.

FIG. 4 is a further illustration of the invention.

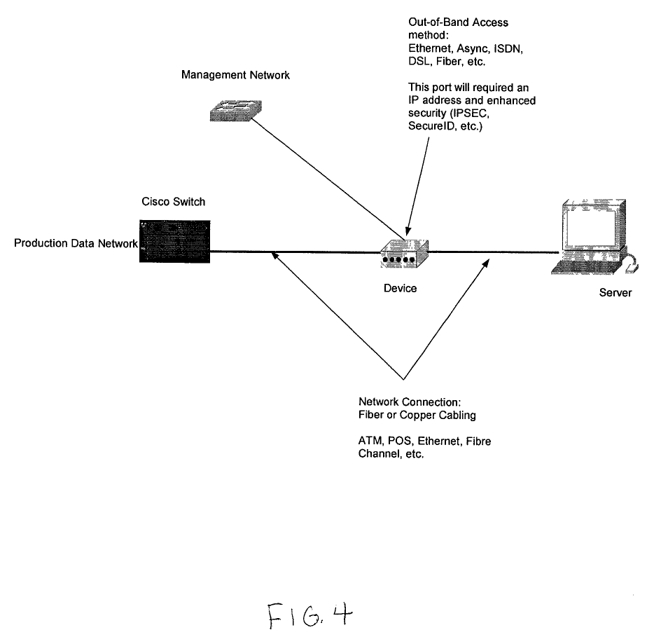

### DETAILED DESCRIPTION OF THE PREFERRED EMBODIMENT

The present invention will now be described in detail with reference to a few preferred embodiments thereof, as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order to not unnecessarily obscure the present invention.

Overall System

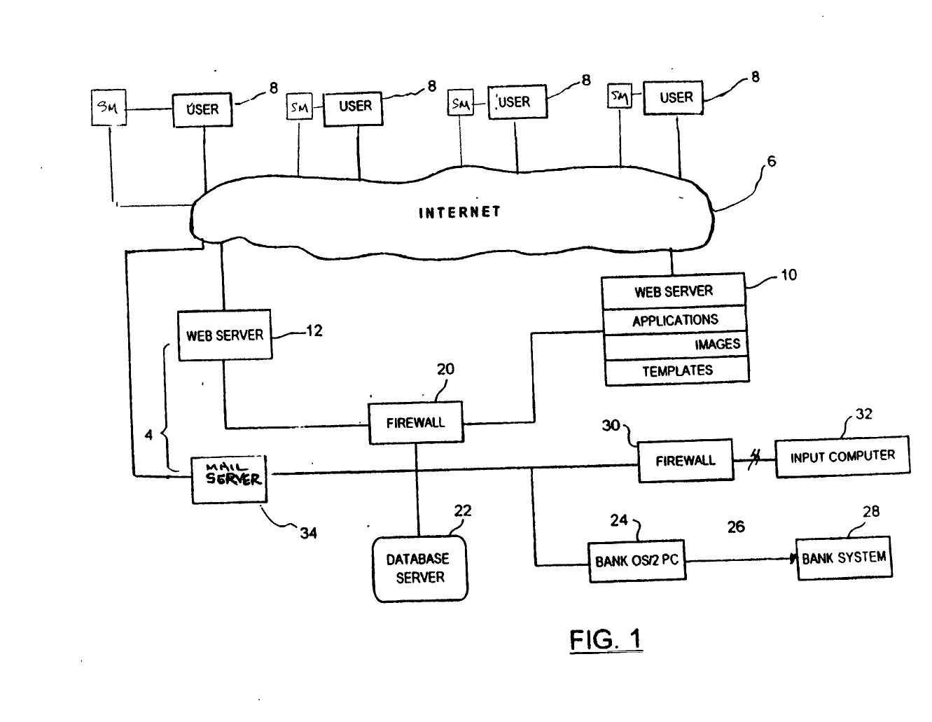

FIG. 1 is an overview of the web-based system, and this is described in relation to the new firewall system of the invention where firewall protection is needed.

With this system multiple users, for instance, remote users 8, access the web site 4 using the Internet 6. Each of the users 8 has a computer terminal with the appropriate software for accessing Internet. The users 8 may be unknown to the web server computers 10 and 12. Each user 8 is allowed to browse the web site and explore how the system functions.

There are several aspects to maintain security of information maintained in a database server 22 and a banking system 28. A firewall 20 normally prevents any user 8 from accessing any of the components behind the firewall 20. In this way the users 8 have access to the web server computers 10 and 12, but only have access to the database server 22 through the firewall 20. The database server 22 maintains, among other things, various database fields with respect to each of the profiles of subject employees, shareholders, directors and other pertinent information of a subject and other related groups and/or competitors. The database 22 maintains the services with a designation associated to determine what data can be browsed by the users 8. Each of the web server computers 10 and 12 allow users 8 to view subject and group categories and actual services and data products which are available from the database.

The web server computers 10 and 12 can be identical and can be duplicated as additional load or growth on the system occurs. The web server computers 10 and 12 share the responsibility for servicing the users of the site. This arrangement provides for expandability of the system by merely adding additional web server computers as necessary.

The system preferably includes an appropriate computer terminal 24 for interfacing with institutions which are connected on-line via the serial connection 26 to the institution computers 28. An SM can be incorporated in the computer system at an appropriate place.

Once a user requires access to a product or service, the user goes through an identification or registration process and the exchange of financial information to allow for credit or debit card payment of the access, data or purchase. This is verified, confirmed and authorized by the appropriate bank system institution 28. Confirmation of the access, purchase or deposit of data, or a service is made by a mail server 34 which sends an E-mail to the user 8 confirming the purchase or deposit. The mail server 34 allows for mail to be received and sent out. Security of the various databases is maintained. Alert messages are generated when an unauthorized access is attempted. Verification messages, authorization messages and confirmation messages are generated as appropriate.

The database server 22 is also designed to interact with an input computer 32 operated by a central database processing resource (CDPR). A firewall 30 serves to prevent unauthorized access to the database server 22 or to the input computer 32. The input computer 32 can input profile data and other data to the database, after appropriate access and/or passwords are entered into the system. Similarly, users 8 through their own computers can use appropriate access codes and passwords to input data to the database server 22. This is tightly controlled for security reasons. The data may only be added to an independent sub-database of the data server 22, and only after scrutiny by the CDPR operator of the database through input computer 32, will this data from users 8 be subsequently added to the main database server 22.

As illustrated in FIG. 1 there are different SM devices which are associated with user computers. Each of the SM devices is shown connected to a user 8 and to the Internet 6. In this manner, the user can communicate directly without the firewall system SM. Alternatively, the SM devices associated with each user 8 can be used as the means for connection with the Internet 6. The SM device is shown with a line connection between the user 8 and the Internet 6. This line connection between the user and SM can be hardwired or infrared. After a message is sent from the user to the SM, this connection is broken.

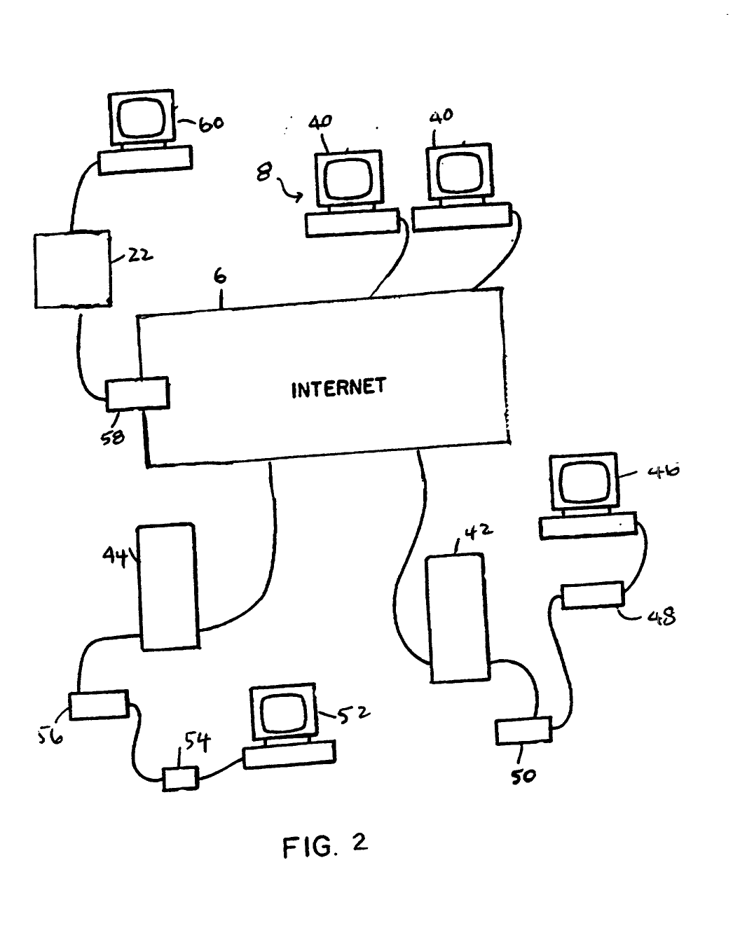

FIG. 2 is an illustration of the Internet and its use in the system of the invention. The Internet 6 is a network of millions of interconnected computers 40 including systems owned by Internet providers 42 and information systems 44 such as America Online (TM). Individual or corporate users may establish connections to the Internet in several ways. A user on a home PC 46 may access data, purchase or access an account through the Internet provider 42. Using a modem 48, the PC user can dial up the Internet provider to connect to a high speed modem 50 which, in turn, provides a full service connection to the Internet. A user 52 may also make a somewhat limited connection to the Internet through a system 20 that provides an Internet gateway connection 54 and 56 to its customers. The database 22 is also connected into the Internet 6 through an appropriate modem or high speed or direct interface 58. The database 22 is operable and maintained by the CDPR operator computer 60. Users of the databases of the invention would access the Internet in an appropriately selected manner.

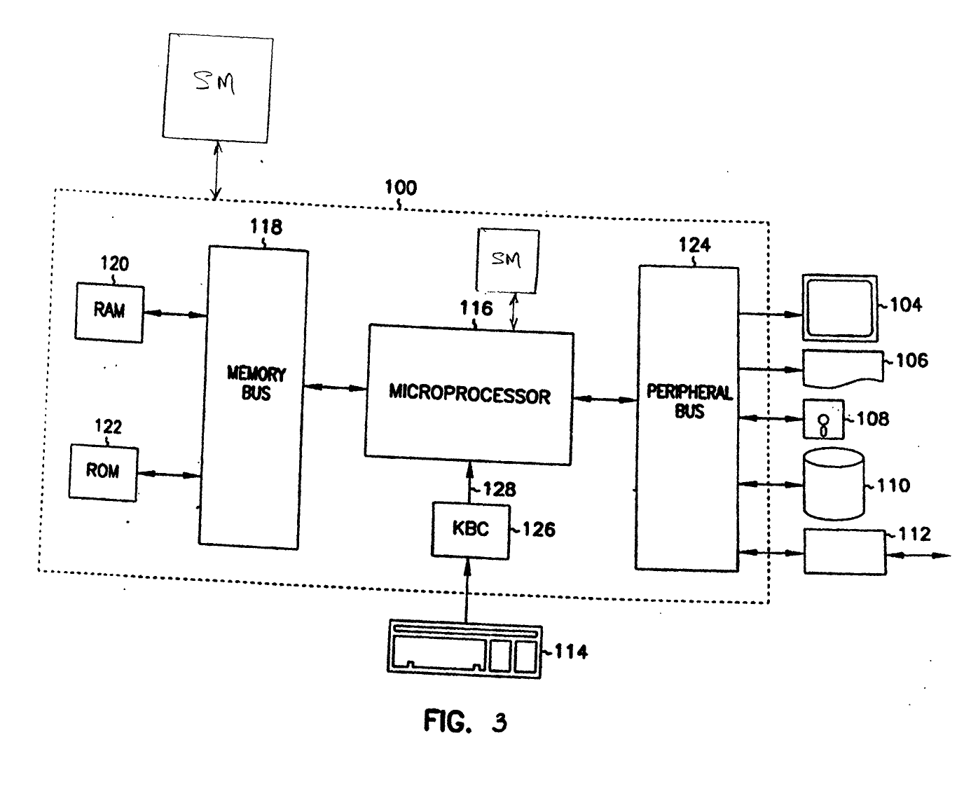

FIG. 3 is a block diagram of an exemplary computer system 100 for practicing various aspects of the invention. The computer system 100 includes a display screen or monitor 104, a printer 106, a disk drive 108, a hard disk drive 110, a network interface 112, and a keyboard 114. The computer system 100 includes a microprocessor 116, a memory bus 118, random access memory (RAM) 129, read only memory (ROM) 122, a peripheral bus 124, and a keyboard controller 126. The computer system 100 can be a personal computer, such as an Apple computer, e.g., an Apple Macintosh (TM), an IBM (TM) personal computer, or a compatible, a workstation computer, such as a Sun Microsystems (TM) or Hewlett-Packard (TM) workstation, or some other type of computer.

Microprocessor 116 is a general purpose digital processor which controls the operation of computer system 100. Microprocessor 116 can be a single-chip processor or can be implemented with multiple components. Using instructions retrieved from memory, the microprocessor 116 controls the reception and manipulation of input data and the output and display of data on output devices.

Memory bus 188 is used by the microprocessor 116 to access RAM 120 and ROM 122. RAM 120 is used by microprocessor 116 as a general storage area and as scratch-pad memory, and can also be used to store input data and processed data. ROM 122 can be used to store instructions or program code followed by microprocessor 116 as well as other data.

Peripheral bus 124 is used to access the input, output, and storage devices used by computer system 10. These devices include the display screen 104, printer device 106, disk drive 108, hard disk drive 110, and network interface 112. The keyboard controller 126 is used to receive input from the keyboard 114 and send decoded symbols for each pressed key to microprocessor 116 over bus 128.

The display screen or monitor 104 is an output device that displays images of data provided by microprocessor 116 via peripheral bus 124 or provided by other components in computer system 100. The printer device 106 when operating as a printer provides an image on a sheet of paper or a similar surface. Other output devices such as a plotter, typesetter, etc. can be used in place of, or in addition to the printer device 106.

The disk drive 108 and hard disk drive 110 can be used to store various types of data. The disk drive 108 facilitates transporting such data to other computer systems, and hard disk drive 110 permits fast access to large amounts of stored data.

Microprocessor 116, together with an operating system, operate to execute computer code and produce and use data. The computer code and data may reside on RAM 120, ROM 122, or hard disk drive 110. The computer code and data could also reside on a removable program medium and loaded or installed onto computer system 100 when needed. Removable program mediums include, for example, CD-ROM, PC-CARD, floppy disk and magnetic tape.

The network interface circuit 112 is used to send and receive data over a network connected to other computer systems. An interface card or similar device and appropriate software implemented by microprocessor 116 can be used to connect computer system 100 to an existing network and transfer data according to standard protocols. As such, the computer system is connectable through an interface device with the Internet 6.

Keyboard 114 is used by a user to input commands and other instructions to computer system 100. Other types of user input devices can also be used in conjunction with the present invention. For example, pointing devices such as a computer mouse, a track ball, a stylus, or a tablet can be used to manipulate a pointer on a screen of a general-purpose computer.

In FIG. 3 there are shown SM devices. The SM device within the computer system 100 is contained in the chassis of a computer, or is infrared or otherwise electronically connected to the computer, for instance to the microprocessor. This connection is broken after a message is sent and the firewall is activated. The SM outside the computer system 100 would operate in the same manner as described.

The SM is never connected to the PC and the network at the same time. The SM is usually free of any software before it is connected to the PC. This means that the different memories or systems (RAM, ROM, magnetic data storage devices, memory buffers, network interface, drivers and their respective software etc) are erased each time.

The present invention can also be embodied as computer readable code on a computer readable medium. The computer readable medium is any data storage device that can store data which can be thereafter read by a computer system. Examples of the computer readable medium include read-only memory, random-access memory, magnetic data storage devices such as diskettes, and optical data storage devices such as CD-ROMs. The computer readable medium can also be distributed over network coupled computer systems so that the computer readable code is stored and executed in a distributed fashion.

This invention is timely with the advent of the possibility that the Justice Department may want Microsoft Corporation to reveal its popular and prevalent operating system source code. Competing software writing program companies can more easily write application programs that can function with fewer conflicts between their software and Microsoft's operating system software. Should Microsoft's source code be revealed hackers will be able to break into computers easily. Since the source code is compiled into computer readable ones and zeros when it is received by Microsoft's customers it is currently very difficult to unscramble or uncompile and allow a computer programmer to read in a normal computer programming language.

This invention would alleviate these fears. If Microsoft's source code is revealed, the Microsoft's source code could be used to create seamless application programs. This could be achieved with few security concerns if the customers used this invention and other inventions such as better encryption systems to create proper firewalls.

What is claimed is:

1. A system for permitting communication between a first computer and a second computer and for enhancing security between the computers and selectively thereby enhancing protection against viruses from infiltrating selectively the first computer or second computer comprising:
a security means physically separated from a main computer;
the security means being for safeguarding and securing a first computer and wherein the security means is physically separated from the first computer and wherein physically separated includes at least one of not being hardwired, or infrared linked to the first computer; and
wherein the security means does not contain essentially any software other than software required for a single transmission of data or communication to be downloaded from a first computer to the security means.

2. A security system for increasing security between a main computer and a network wherein the security system includes only minimal circuitry, the circuitry being for the essentially sole purpose of operating the security system, the security system comprising hardware for operating the security system and wherein after each use of the security system, the necessary software of a security system downloaded from a user's computer or a main computer is selectively erased from the security system.

3. A system for a user to effect at least one of connection or disconnection of the fiber or copper or other network or Internet connectivity from a first computer, said first computer being selectively a server or computer or router or switch or other computer, the first computer being connected via the Internet or other network whereby the user is permitted to secure the first computer from access by others for privacy and for preventing unauthorized use of the data in the computer equipment comprising:
means for physcialy selectively disconnecting or connecting the connection with a first computer from a computer of a user.

4. The system as claimed in claim 3 wherein user is a bank or financial institution which disconnects remotely the first computer via the internet or other network thereby to secure the monies held electronically in accounts.

5. The system as claimed in claim 3 wherein the user acc4sses the first computer from a remote location through access to the Internet or other network thereby to selectively connect and disconnect the first computer without substantially effecting the network architecture or codes in routers or other computer apparatus associated with the operation of the first computer.

6. The system of claim 3 for applying security in a remote access to the first computer comprising selectively a device, selectively being a solenoid, solid state devices, chip based devices, liquid based devices, chemical based devices, solid state devices, other electronic devices, fuel based engines, fuel cell devices, for physically detaching at least one of the fiber, copper, or other data transfer cable or connectivity, and means for the device to receive a signal from the remote user effect the connectivity or disconnectivity.

7. A system for the use of the machine of the Internet or other network to remotely control the connection and disconnection of fiber, copper, or other data transfer cable or connectivity connected to computer equipment that it physically located in different physically remote facilities comprising:
permitting the user to remotely connect or disconnect the connectivity with different computer equipment selectively simultaneously or in any specific order.

8. A system of claim 3 wherein the computer includes a database of bank records of transfers and other electronic security sensitive data, and wherein transmissions are authorized and/or approved and/or recorded or data stored regarding such data transfer or transmission.

9. A system as claimed in claim 4 wherein the user selectively updates a bank record or balance updated, or other action requiring electronic security or privacy, simultaneously as the user's computer authorizes and records the data transfer.

10. A system as claimed in claim 3 wherein when the computer of a bank is not disconnected, then a bank transfer is not authorized.

11. A computerized system having security for network communications comprising:
software for directing at least one of the simultaneous or successive remote connections or disconnections of a physically remotely located computer;
means for allowing the user to confirm a disconnection, selectively physical, of the user computer from selectively from at least one of the Internet or another local area network.

12. A system as claimed in claim 2 comprising use of the device without disturbing or corrupting any technical elements of the network architecture or systems architecture.
